(19) United States
(12) Patent Application Publication
(10) Pub. No.: US 2023/0154242 A1
(43) Pub. Date: May 18, 2023

(54) AUTONOMOUS VEHICLE, CONTROL SYSTEM FOR REMOTELY CONTROLLING THE SAME, AND METHOD THEREOF

(71) Applicants: Hyundai Motor Company, Seoul (KR); Kia Corporation, Seoul (KR)

(72) Inventor: Dong Hyuk KIM, Hanam-Si (KR)

(73) Assignees: Hyundai Motor Company, Seoul (KR); Kia Corporation, Seoul (KR)

(21) Appl. No.: 17/879,533

(22) Filed: Aug. 2, 2022

(30) Foreign Application Priority Data
Nov. 18, 2021 (KR) 10-2021-0159630

(51) Int. Cl. G07C 5/00; G05D 1/00; B60W 60/00; B60W 50/04; B60Q 1/50; B60Q 5/00; G06Q 50/26; G06Q 50/30

(52) U.S. Cl. CPC G07C 5/008; G05D 1/0011; B60W 60/001; B60W 50/045; B60Q 1/5035; B60Q 5/005; G06Q 50/265; G06Q 50/30; B60W 2556/45; B60Q 1/52

(57) ABSTRACT

An autonomous vehicle, a control system for remotely controlling the same, and a method thereof provides a control system including a processor configured to search for an external person around an autonomous vehicle when receiving a request for help of the external person from the autonomous vehicle, and to request the help of the external person through a user terminal of the searched external person or an external notification of the autonomous vehicle.

### CROSS-REFERENCE TO RELATED APPLICATION

The present application claims priority to Korean Patent Application No. 10-2021-0159630, filed on Nov. 18, 2021, the entire contents of which is incorporated herein for all purposes by this reference.

### BACKGROUND OF THE PRESENT DISCLOSURE

### Field of the Present Disclosure

The present disclosure relates to an autonomous vehicle, a control system for remotely controlling the same, and a method thereof, and more particularly, to a technique for requesting a vehicle occupant or an external person to take vehicle action to control an autonomous vehicle.

### Description of Related Art

As an electronic technique of a vehicle develops, an interest in an autonomous vehicle that drives to a destination by recognizing a driving environment of the vehicle itself without manipulation of a driver is growing more and more.

An autonomous vehicle refers to a vehicle capable of operating by itself without manipulation of a driver or an occupant.

However, there may be situations in which driving in an autonomous driving mode is impossible. There may be a case in which a situation in which driving is impossible cannot be solved even through remote control due to a simple breakdown of the vehicle, an obstacle around the vehicle, etc.

There is a problem in that the autonomous vehicle cannot start at all because it cannot be solved when may be solved only with a simple help of an external person.

The information included in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an autonomous vehicle, a control system for remotely controlling the same, and a method thereof, configured for securing autonomous driving safety by changing a situation where autonomous driving is impossible to a situation where the autonomous driving is possible through a simple action by requesting a vehicle occupant or a surrounding person to help when the autonomous driving is impossible.

The technical objects of the present disclosure are not limited to the objects mentioned above, and other technical objects not mentioned may be clearly understood by those skilled in the art from the description of the claims.

An exemplary embodiment of the present disclosure provides a control system including a processor configured to search for an external person around an autonomous vehicle when receiving a request for help of the external person from the autonomous vehicle, and to request the help of the external person through a user terminal of the searched external person or an external notification of the autonomous vehicle.

In an exemplary embodiment of the present disclosure, the processor is configured to determine an abnormal state of the autonomous vehicle by monitoring the autonomous vehicle.

In an exemplary embodiment of the present disclosure, the processor is configured to determine an external abnormal state of the autonomous vehicle according to vehicle information received from the autonomous vehicle or CCTV obtaining information of surroundings of the autonomous vehicle.

In an exemplary embodiment of the present disclosure, the processor may search for the external person positioned within a predetermined distance from the autonomous vehicle.

In an exemplary embodiment of the present disclosure, the processor may search for the external person provided with a user terminal in which a predetermined application is provided.

In an exemplary embodiment of the present disclosure, the processor, may search for the external person who is able to provide a callout engineer for customer service when the callout engineer for the customer service is required due to a failure of the autonomous vehicle, may search for the external person who is able to provide a predetermined equipment when the predetermined equipment is required, and may search for an ambulance crew or a police officer who is able to move to the autonomous vehicle when abnormality occurs in an occupant of the autonomous vehicle.

In an exemplary embodiment of the present disclosure, the processor may request the external person positioned within a predetermined distance from the autonomous vehicle to help through manipulation of an external notification window or external lighting of the autonomous vehicle.

In an exemplary embodiment of the present disclosure, the processor is configured to transmit a help request notification through an application of the user terminal of the external person

In an exemplary embodiment of the present disclosure, the processor, when requesting the help through the user terminal of the external person, may provide at least one of a position of the autonomous vehicle, contents of the help request, or contents of compensation for providing the help to the user terminal.

In an exemplary embodiment of the present disclosure, the processor may pay a fee as compensation for providing the help when the help is terminated after receiving approval for the request for the help of the user terminal of the external person.

An exemplary embodiment of the present disclosure provides an autonomous vehicle, including: an autonomous driving control apparatus including a processor that is configured to check a vehicle state of the autonomous vehicle to determine whether human help is required to resolve a situation in which autonomous driving control of the autonomous vehicle is impossible, and when the human help is required, requests an in-vehicle occupant to help or the external person to help through a control system, and an interface device outputs a phrase or a voice to request the help from the external person through the control system or to request the help from the in-vehicle occupant by remote control of the control system.

In an exemplary embodiment of the present disclosure, the processor may notify an end of external help through the interface device when receiving a notification of the end of the external help from the control system.

In an exemplary embodiment of the present disclosure, it may further include a communication device that is configured to perform communication to request external help through the control system, and transmits vehicle information together when requesting the external help through the control system.

In an exemplary embodiment of the present disclosure, the processor is configured to output a text or voice requesting help through an external notification window of the autonomous vehicle or blink an external light of the autonomous vehicle in accordance with a command of the control system.

In an exemplary embodiment of the present disclosure, cases that require the human help may include at least one of a case that requires a callout engineer for customer service, a case that requires predetermined equipment, a case that abnormality occurs in an occupant of the vehicle, a case that an obstacle outside the vehicle needs to be moved, or a case that a door or a tailgate of the vehicle is open.

In an exemplary embodiment of the present disclosure, the case that requires the callout engineer for customer service may include at least one of tire replacement, air pressure injection, replacement of insufficient washer fluid or antifreeze, or lamp replacement.

In an exemplary embodiment of the present disclosure, the case that requires the predetermined equipment may include a case in which a request for cooperation of a loading forklift is required or a case in which cleaning of autonomous driving sensors of the vehicle is required.

In an exemplary embodiment of the present disclosure, the processor may request help from the in-vehicle occupant through the interface device when it is necessary to move an obstacle outside the vehicle, or when the door or the tailgate is open.

An exemplary embodiment of the present disclosure provides a remote control method for an autonomous vehicle, including: checking a vehicle state of the autonomous vehicle; determining whether human help is required to resolve a situation in which the autonomous driving control is impossible when the vehicle state is a situation in which autonomous driving control of the autonomous vehicle is impossible; and requesting help from an in-vehicle occupant or an external person through a control system when the human help is required.

In an exemplary embodiment of the present disclosure, it may further include searching for the external person around an autonomous vehicle when receiving a request for help of the external person from the autonomous vehicle, and requesting the help through a user terminal of the searched external person or an external notification of the autonomous vehicle, by the control system.

According to the present technique, it is possible to secure autonomous driving safety by changing a situation where autonomous driving is impossible to a situation where the autonomous driving is possible through a simple action by requesting a vehicle occupant or a surrounding person to help when the autonomous driving is impossible.

Furthermore, various effects which may be directly or indirectly identified through the present specification may be provided.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a block diagram showing a configuration of a system for remotely controlling an autonomous vehicle according to an exemplary embodiment of the present disclosure.

FIG. 2A illustrates a view for describing a sensing device of an autonomous vehicle according to an exemplary embodiment of the present disclosure.

FIG. 2B illustrates a sensing range of a sensing device of an autonomous vehicle according to an exemplary embodiment of the present disclosure.

FIG. 3 illustrates a flowchart showing a method for controlling a vehicle action by an external person of an autonomous vehicle according to an exemplary embodiment of the present disclosure.

FIG. 4 illustrates a determining system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. Furthermore, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms have the same meanings as those which are generally understood by those skilled in the technical field of the present disclosure to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

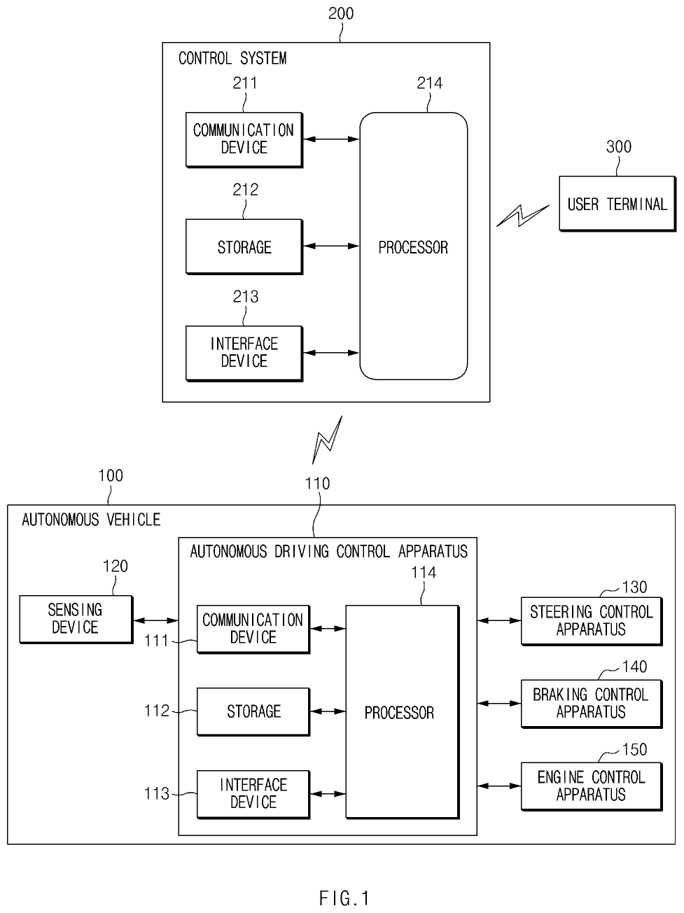

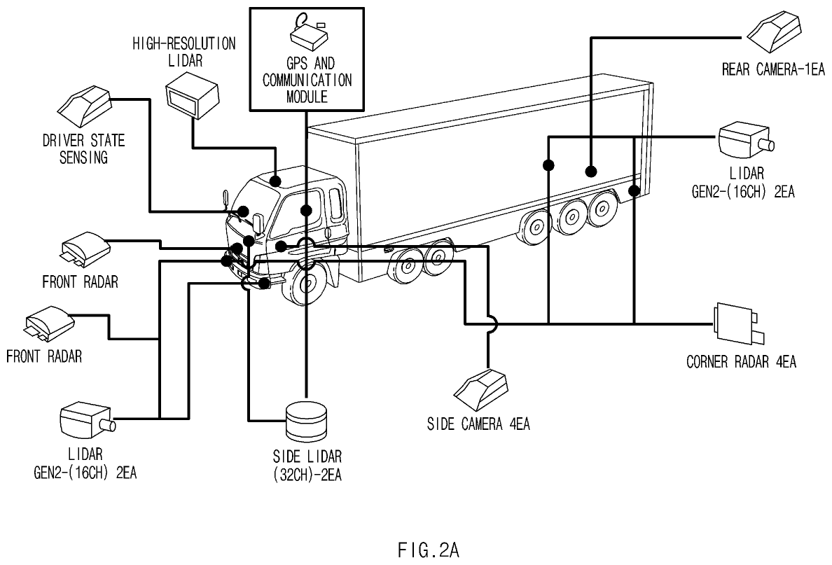

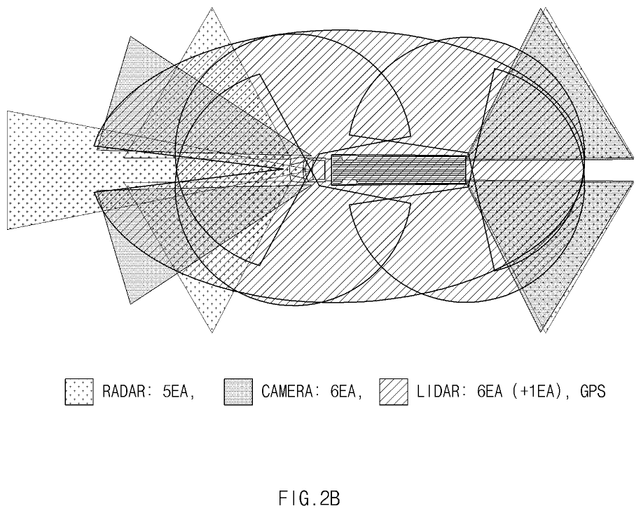

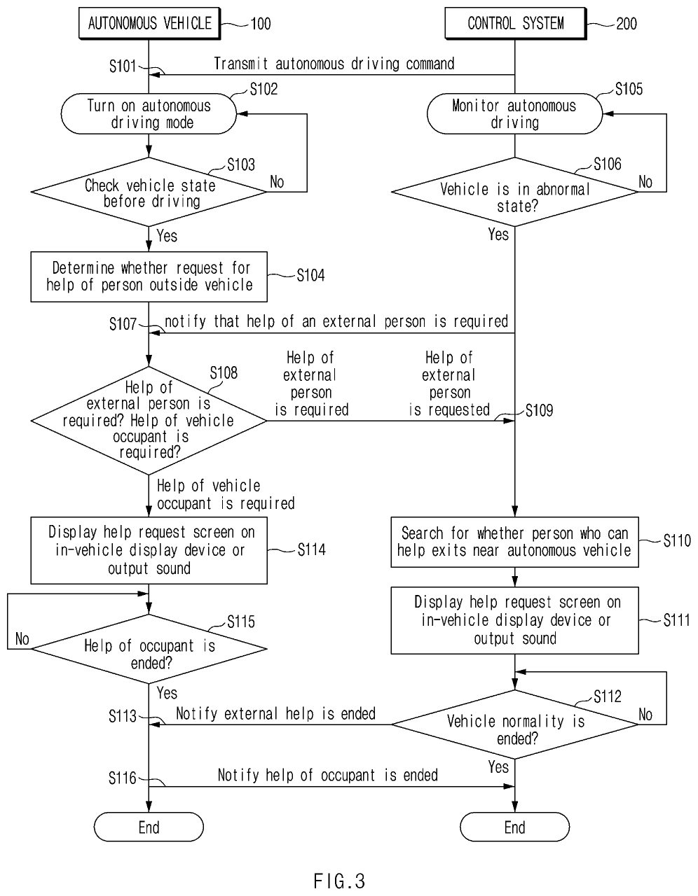

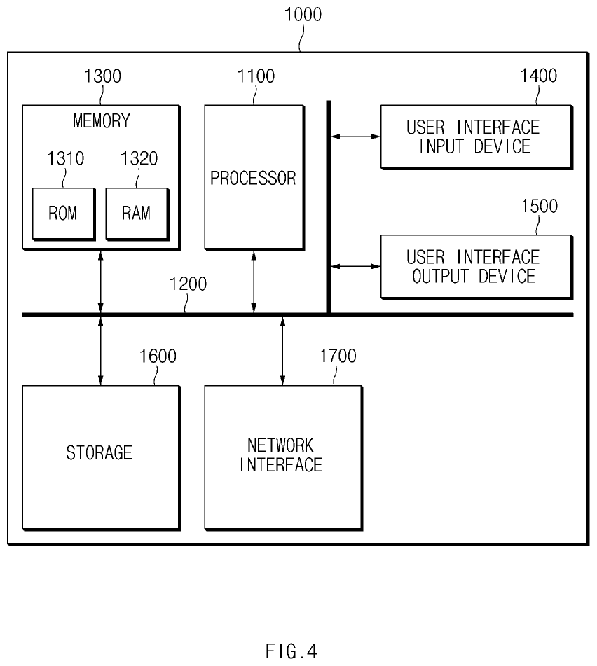

Hereinafter, various exemplary embodiments of the present disclosure will be described in detail with reference to FIG. 1, FIG. 2A, FIG. 2B, FIG. 3, and FIG. 4.

FIG. 1 illustrates a block diagram showing a configuration of a system for remotely controlling an autonomous vehicle according to an exemplary embodiment of the present disclosure.

Referring to FIG. 1, the remote control system for an autonomous vehicle according to an exemplary embodiment of the present disclosure includes an autonomous vehicle 100 and a control system 200, and remote control may be performed through communication between the autonomous vehicle 100 and the control system 200. In the instant case, the autonomous vehicle 100 may include a vehicle that autonomously drives regardless of presence of an occupant.

The autonomous vehicle 100 may include an autonomous driving control apparatus 120, a sensing device 120, a steering control apparatus 130, a braking control apparatus 140, and an engine control apparatus 150.

The autonomous driving control apparatus 110 according to the exemplary embodiment of the present disclosure may be implemented inside the vehicle. In the instant case, the autonomous driving control apparatus 110 may be integrally formed with internal control units of the vehicle, or may be implemented as a separate device to be connected to control units of the vehicle by a separate connection means.

The autonomous driving control apparatus 110 may check a vehicle state of the autonomous vehicle to determine whether human help is required to resolve a situation in which autonomous driving control of the autonomous vehicle is impossible, and when the human help is required, may request an in-vehicle occupant to help or an external person to help through a control system. In the instant case, the human help may include a case in which a person must directly move to the autonomous vehicle 100 to take action. In the instant case, the person may include an in-vehicle occupant, a callout engineer for customer service, an ambulance crew, a police officer, a pedestrian around the autonomous vehicle 100, and a manager of a specific place (e.g., gas station, convenience store, parking lot) around the autonomous vehicle 100. The person may be provided with a user terminal 300 in which an application for requesting help is pre-installed. Furthermore, the person may include a person existing within a predetermined distance from the autonomous vehicle 100.

Referring to FIG. 1, the autonomous driving control apparatus 110 may include a communication device 111, a storage 112, an interface device 113, and a processor 114.

The communication device 111 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include controller area network (CAN) communication, Local Interconnect Network (LIN) communication, flex-ray communication, Ethernet communication, and the like.

Furthermore, the communication device 111 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), Ethernet communication, etc. Furthermore, short-range communication technique may include Bluetooth, ZigBee, ultra wideband (UWB), radio frequency identification (RFID), infrared data association (IrDA), and the like. For example, the communication device 111 may perform wireless communication with the control system 200, may transmit vehicle position information (e.g., vehicle coordinates), surrounding information (e.g., obstacle information), vehicle information (e.g., vehicle interior and external image data, etc.), a remote control request, etc. to the control system 200, and may receive an autonomous driving command, and the like from the control system 200.

The storage 112 may store sensing results of the sensing device 120, information received from the control system 200, data and/or algorithms required for the processor 114 to operate, and the like. As an exemplary embodiment of the present disclosure, the storage 112 may store vehicle information, image data captured through a camera, a command received from the control system 200, etc.

The storage 112 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 113 may include an input means for receiving a control command from a user and an output means for outputting an operation state of the autonomous driving control apparatus 110 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display. For example, the input means may receive from an occupant a confirmation that a help request has been approved or completed to be ended. To the present end, the input means may receive such an input from the occupant through a mouse, a keyboard, a touch screen, a microphone, or the like.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated. For example, the output means may output contents of the help request in text or voice.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

As an exemplary embodiment of the present disclosure, the interface device 113 may be implemented as a head-up display (HUD), a cluster, an audio video navigation (AVN), a human machine interface (HM), a user setting menu (USM), or the like.

The processor 114 may be electrically connected to the communication device 111, the storage 112, the interface device 113, and the like, may electrically control each component, and may be an electrical circuit that executes software commands, performing various data processing and calculations described below.

The processor 114 may process a signal transferred between components of the autonomous driving control apparatus 110, and may perform overall control so that each of the components can perform its function normally.

The processor 114 may be implemented in a form of hardware, software, or a combination of hardware and software, or may be implemented as microprocessor, and may be, e.g., an electronic control unit (ECU), a micro controller unit (MCU), or other subcontrollers mounted in the vehicle.

The processor 114 may check a vehicle state of the autonomous vehicle to determine a situation in which autonomous driving control of the autonomous vehicle is impossible and whether human help is required to resolve the situation in which autonomous driving control is impossible, and when the human help is required, may request an in-vehicle occupant or an external person to help through a control system.

The processor 114 may transmit information for an external help request to the control system 200 when requesting an external person to help. In the instant case, the information for the external help request may include vehicle position information (e.g., vehicle coordinates), vehicle surrounding image information, vehicle surrounding information (e.g., obstacles, pedestrians, and fixed objects), map information, and the like.

In the case of tire replacement, air pressure injection, and replacement of insufficient washer fluid or antifreeze, when a visit to a service center is unnecessary for lamp replacement etc., and when a callout service is required, the processor 114 may request help of an external person through the control system 200.

When special equipment is required, that is, when cooperation of a loading forklift or cleaning of autonomous driving sensors of the vehicle is required, or when an ambulance or a police vehicle is required due to occupant abnormality, the processor 114 may request help of an external person through the control system 200.

When autonomous driving control of the autonomous vehicle 100 becomes impossible due to a light obstacle such as an animal on or under a vehicle, cones for parking prohibition, etc., and thus needs to be moved, the processor 114 may determine whether there is an in-vehicle occupant to request the in-vehicle occupant to help, and when the in-vehicle occupant does not exist, may request help of an external person through the control system 200.

When the autonomous driving control of the autonomous vehicle 100 is impossible because a door, a tailgate, a fuel port, or the like open, and a person has to take action to directly close the door, the tailgate, or the fuel port, the processor 114 may determine whether there is an in-vehicle occupant to request the in-vehicle occupant to help, and when the in-vehicle occupant does not exist, may request help of an external person to the control system 200.

The processor 114 may output a phrase or voice for requesting an occupant in the vehicle to help through the interface device 213 in the vehicle.

The processor 114 may request a person outside of the autonomous vehicle 100 to help through an external notification window of the autonomous vehicle or external lighting such as a head light or an emergency light in accordance with a command of the control system 200. In the instant case, the external notification window of the vehicle may be mounted on rear of the vehicle, window glass in front of the vehicle, left and right side windows of the vehicle, and the like. Furthermore, the processor 114 may control the head light or the emergency light to blink several times to request help, and may sound a horn to request help.

The processor 114 may start autonomous driving control when a situation in which the autonomous driving control is impossible is resolved with help of an in-vehicle occupant or an external person.

The sensing device 120 may include one or more sensors that detect an obstacle, e.g., a cone, an animal, a pedestrian, and the like, positioned around the vehicle, and measure a position of the obstacle, a distance therewith and/or a relative speed thereof.

The sensing device 120 may include a plurality of sensors to detect an external or internal object of the vehicle, to obtain information related to a position of the external object, a speed of the external object, a moving direction of the external object, and/or a type of the external object (e.g., animals, vehicles, pedestrians, bicycles, or motorcycles, etc.). To the present end, the sensing device 120 may include an ultrasonic sensor, a radar, a camera (inside and outside the vehicle), a laser scanner and/or a corner radar, a Light Detection and Ranging (LiDAR), an acceleration sensor, and the like.

FIG. 2A illustrates a view for describing a sensing device of an autonomous vehicle according to an exemplary embodiment of the present disclosure, and FIG. 2B illustrates a sensing range of a sensing device of an autonomous vehicle according to an exemplary embodiment of the present disclosure.

Referring to FIG. 2A, the sensing device 120 may include a front radar mounted on the front of the vehicle, a Light Detection and Ranging (LiDAR), a side LiDAR, a side camera, a corner radar, a high-resolution LiDAR, a rear camera, a rear LiDAR, etc. Furthermore, referring to FIG. 2B, a surrounding situation may be detected through radars, cameras, and LiDARs of the front, rear, and side of the vehicle.

The steering control apparatus 130 may be configured to control a steering angle of a vehicle, and may include a steering wheel, an actuator interlocked with the steering wheel, and a controller configured for controlling the actuator.

The braking control apparatus 140 may be configured to control braking of the vehicle, and may include a controller that controls a brake thereof.

The engine control apparatus 150 may be configured to control engine driving of a vehicle, and may include a controller that controls a speed of the vehicle.

When receiving a request for help of an external person from the autonomous vehicle 100, the control system 200 searches for an external person around the autonomous vehicle 100, and may request help through a user terminal of the searched external person or an external notification of the autonomous vehicle 100.

The control system 200 may include a communication device 211, a storage 212, an interface device 213, and a processor 214.

The communication device 211 is a hardware device implemented with various electronic circuits to transmit and receive signals through a wireless or wired connection, and may transmit and receive information based on in-vehicle devices and in-vehicle network communication techniques. As an exemplary embodiment of the present disclosure, the in-vehicle network communication techniques may include controller area network (CAN) communication, Local Interconnect Network (LIN) communication, flex-ray communication, Ethernet communication, and the like.

Furthermore, the communication device 211 may perform communication by use of a server, infrastructure, or third vehicles outside the vehicle, and the like through a wireless Internet technique or short range communication technique. Herein, the wireless Internet technique may include wireless LAN (WLAN), wireless broadband (Wibro), Wi-Fi, Worldwide Interoperability for Microwave Access (WiMAX), etc. Furthermore, short-range communication technique may include Bluetooth, ZigBee, ultra wideband (UWB), radio frequency identification (RFID), infrared data association (IrDA), and the like. For example, the communication device 211 may perform wireless communication with the autonomous vehicle 100, and may perform wireless communication with the user terminal 300 in which a predetermined application is provided. For example, the communication device 211 may transmit a help request text message to the user terminal 300 of an external person in the vicinity of the autonomous vehicle 100, or may transmit a help request notification through an application provided in the user terminal 300.

The storage 212 may store information received from the autonomous vehicle 100, and data and/or algorithm required for the processor 214 to operate, and the like.

As an exemplary embodiment of the present disclosure, the storage 212 may store vehicle surrounding image data and vehicle interior image data, etc. received from the autonomous vehicle 100.

The storage 212 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The interface device 213 may include an input means configured for receiving a control command from an operator and an output means for outputting an operation state of the control system 200 and results thereof. Herein, the input means may include a key button, and may further include a mouse, a keyboard, a touch screen, a microphone, a joystick, a jog shuttle, a stylus pen, and the like. Furthermore, the input means may further include a soft key implemented on the display. For example, the interface device 213 may display an abnormal state of the vehicle (e.g., whether autonomous driving control cannot be started because there is an obstacle around the vehicle, a vehicle failure state, etc.) based on vehicle data received from the autonomous vehicle 100 or information received from a closed-circuit television (CCTV) around the autonomous vehicle 100. For example, the interface device 213 may include all communication terminals such as a personal computer (PC), a notebook computer, a smartphone, a tablet PC, a pad, a personal digital assistant (PDA), and a wearable device.

The output means may include a display, and may further include a voice output means such as a speaker. In the instant case, when a touch sensor formed of a touch film, a touch sheet, or a touch pad is provided on the display, the display may operate as a touch screen, and may be implemented in a form in which an input device and an output device are integrated.

In the instant case, the display may include at least one of a liquid crystal display (LCD), a thin film transistor liquid crystal display (TFT LCD), an organic light emitting diode display (OLED display), a flexible display, a field emission display (FED), or a 3D display.

The processor 214 may be electrically connected to the communication device 211, the storage 212, the interface device 213, and the like, may electrically control each component, and may be an electrical circuit that executes software commands, performing various data processing and determinations described below.

The processor 214 may process a signal transferred between components of the control system 200, and may perform overall control so that each of the components can perform its function normally. The processor 214 may be implemented in a form of hardware, software, or a combination of hardware and software, or may be implemented as microprocessor.

The processor 214 may transmit an autonomous driving command to the autonomous vehicle 100, and may monitor the autonomous vehicle 100 to determine an abnormal state of the autonomous vehicle 100.

The processor 214 may periodically collect vehicle information (e.g., a vehicle position, vehicle surrounding image data, etc.) from the autonomous vehicle 100, may collect image information such as an image of a CCTV around the autonomous vehicle 100, and may monitor the abnormal state of the autonomous vehicle 100 based on the collected information. The processor 214 may determine external abnormality of the autonomous vehicle 100.

When receiving a request for external help from the autonomous vehicle 100, the processor 214 may search for an external person who can provide help in the vicinity of the autonomous vehicle 100.

When at least one of a door, a tailgate, or a fuel port of the autonomous vehicle 100 needs to be open, and when it is necessary to move an obstacle existing outside the autonomous vehicle 100, the processor 214 may search for an external person positioned within a predetermined distance from the autonomous vehicle 100.

Furthermore, the processor 214 may search for an external person who can provide a callout customer service when the callout customer service is required due to a failure of the autonomous vehicle 100, may search for an external person who can provide special equipment when the special equipment is required, and may search for an ambulance crew or a police officer who can move to the autonomous vehicle 100 when abnormality occurs in an occupant of the autonomous vehicle 100. In the instant case, the external person may be provided with the user terminal 300 in which a predetermined application is provided, and the processor 214 may notify a help request through the application of the user terminal 300.

Furthermore, when at least one of a door, a tailgate, or a fuel port of the autonomous vehicle 100 needs to be open, and when it is necessary to move an obstacle existing outside the autonomous vehicle 100, the processor 214 may request an external person positioned within a predetermined distance from the autonomous vehicle 100 to help through manipulation of an external notification window or external lighting of the autonomous vehicle 100.

When requesting help through the user terminal 300 of an external person, the processor 214 may provide the user terminal 300 with at least one of a position of the autonomous vehicle 100, contents of a request for help, or contents of compensation for providing help, to allow an external person to check the position of the autonomous vehicle 100, the contents of the request for the help, and the contents of the compensation for providing the help. Accordingly, the external person may input approval or rejection of the help request through the user terminal 300.

When the help by the external person is finished, the processor 214 may pay a fee as compensation for providing the help to the external person.

Accordingly, in the case of monitoring whether the autonomous vehicle 100 is abnormal or receiving a request for help of the autonomous vehicle 100, the control system 200 of the present disclosure may search for an external person who can provide help to the autonomous vehicle 100 to request the external person to help, and when a situation where autonomous driving control is impossible may be resolved with simple breakdown or simple measures, may increase efficiency of an autonomous driving system by allowing a vehicle occupant or an external person to simply take action to continue the autonomous driving.

Hereinafter, a method for controlling a vehicle action by an external person of an autonomous vehicle according to an exemplary embodiment of the present disclosure will be described in detail with reference to FIG. 3. FIG. 3 illustrates a flowchart showing a method for controlling a vehicle action by an external person of an autonomous vehicle according to an exemplary embodiment of the present disclosure.

Hereinafter, it is assumed that the autonomous driving control apparatus 110 of the autonomous vehicle 100 of FIG. 1 and the control system 200 perform processes of FIG. 3. Furthermore, in the description of FIG. 3, it may be understood that operations described as being performed by each apparatus and system are controlled by a processor of each of the systems.

Referring to FIG. 3, when receiving an autonomous driving command from the control system 200 (S101), the autonomous vehicle 100 turns on an autonomous driving mode (S102), and checks a vehicle state before starting driving of the autonomous vehicle 100 (S103).

In the instant case, the checking of the vehicle state before starting the driving is to check whether the vehicle is in a state that can start autonomous driving, and may include whether the vehicle needs maintenance, a situation that requires surrounding help, and a situation where an in-vehicle occupant or an external person must take action to start autonomous driving.

The autonomous vehicle 100 determines whether a request for help of a person outside the vehicle is required as a result of checking the vehicle state before being driven (S104).

Meanwhile, the control system 200 may transmit an autonomous driving command to the autonomous vehicle 100, and then may monitor the autonomous vehicle 100 (S105) to check whether the vehicle is in an abnormal state (S106). In the instant case, the control system 200 may determine abnormality outside the vehicle based on information collected from the autonomous vehicle 100 or obtaining information of, e.g., a surrounding CCTV. For example, in the case where the vehicle door or tailgate is open and manual operation is required, the control system 200 may determine as an abnormal state of the vehicle when it is necessary to move an external obstacle (an animal around the vehicle, cones for parking prohibition, a light obstacle, etc.).

Accordingly, the control system 200 notifies the autonomous vehicle 100 that help of an external person is required when detecting the abnormal state of the vehicle (S107). In the instant case, the autonomous vehicle 100 may transmit vehicle data such as vehicle position information (coordinates), vehicle surrounding information (surrounding object information the current changing the color of the etc.), and map information (current path of the vehicle) together therewith when notifying the control system 200 of a situation requiring help.

Meanwhile, the autonomous vehicle 100 determines a situation where help of an external person is required or a situation where help of a vehicle occupant is required (S108).

In the situation where the help of the external person is required, the autonomous vehicle 100 request the help of the external person through the control system 200 (S109).

Accordingly, the control system 200 searches for whether a person who can help is present in the vicinity of the autonomous vehicle 100 (S110). In the instant case, the person who can help may include a person within a predetermined distance from the vehicle, such as a passerby, a parking lot manager, an employee of a nearby store, etc., and may include a person who has provided a predetermined application on a user terminal thereof. That is, the control system 200 may search for a person who is provided with the user terminal 300 in which the predetermined application is provided among persons existing within the predetermined distance from the autonomous vehicle 100.

Accordingly, the control system 200 may output a help request notification using an application of a user terminal of a nearby person, and may output a help request notification through an external notification window of the autonomous vehicle 100 (S111). In the instant case, the control system 200 may output a text or voice requesting help through the external notification window of the autonomous vehicle 100, and may request help by blinking an external light such as a head light or an emergency light.

In the instant case, the user terminal 300 of the nearby person may display position information of the autonomous vehicle 100 in need of help, contents of the request for help, a payment amount for the help, and the like. Accordingly, the nearby person may input approval or rejection of the help request through the user terminal 300, and a response to the approval or rejection inputted may be transferred to the control system 200. Accordingly, according to an exemplary embodiment of the present disclosure, it is possible to take a simple action by requesting an application user positioned in a short distance of the autonomous vehicle 100 to help, to get out of the situation where autonomous driving is impossible.

When an approval response is received from the user terminal 300, the control system 200 checks whether external help has ended after a predetermined time period (S112). That is, the control system 200 may determine whether the vehicle abnormal state is terminated by the help of the user who has approved the help request. After the user (nearby person) takes a necessary action on the vehicle, it is possible to notify the control system 200 that the help has ended through his or her user terminal 300. Furthermore, the control system 200 may confirm that the abnormal state of the vehicle has ended through information such as an image of a CCTV after a predetermined time period has elapsed.

Accordingly, the control system 200 may notify a help ending situation to the autonomous vehicle 100 (S113).

Meanwhile, when it is determined in step S108 that the vehicle occupant needs help, the autonomous vehicle 100 may display a help request screen or output a voice on a display device in the autonomous vehicle 100 (S114). Accordingly, an occupant boarding in the autonomous vehicle 100 may take action after confirming the help request.

Thereafter, the autonomous vehicle 100 may check whether the help of the occupant has ended after a predetermined time period (S115). In the instant case, after the occupant takes action on the help request, the autonomous vehicle 100 may determine the help ending situation because the occupant may input a help end through a display device in the autonomous vehicle 100. Furthermore, the autonomous vehicle 100 may determine the help ending situation by determining a vehicle internal or external situation through the sensing device 120. For example, the autonomous vehicle 100 may receive an approval of a request for help and confirmation of ending the help from an occupant through a mouse, a keyboard, a touch screen, a microphone, or the like.

Thereafter, the autonomous vehicle 100 may notify the control system 200 that the help of the occupant has ended.

Accordingly, according to an exemplary embodiment of the present disclosure, the autonomous vehicle may determine whether autonomous driving is not possible before starting to drive, and when help of a vehicle occupant or an external person is required, may resolve a situation in which the autonomous driving is not possible by requesting the help of the vehicle occupant through the in-vehicle display device or by requesting the help of the external person through the control system 200.

Furthermore, according to an exemplary embodiment of the present disclosure, it is possible to induce more active help provision by providing compensation (cost) to the external person who provides the help.

FIG. 4 illustrates a computing system according to an exemplary embodiment of the present disclosure.

Referring to FIG. 4, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Furthermore, the terms such as “unit”, “module”, etc. Included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control system comprising
a processor configured to search for an external person around an autonomous vehicle when receiving a request for help of the external person from the autonomous vehicle, and to request the help of the external person through a user terminal of the searched external person or an external notification of the autonomous vehicle.

2. The control system of claim 1, wherein the processor is configured to determine an abnormal state of the autonomous vehicle by monitoring the autonomous vehicle.

3. The control system of claim 1, wherein the processor is configured to determine an external abnormal state of the autonomous vehicle according to vehicle information received from the autonomous vehicle or a closed-circuit television (CCTV) obtaining information of surroundings of the autonomous vehicle.

4. The control system of claim 1, wherein the processor is configured to search for the external person positioned within a predetermined distance from the autonomous vehicle.

5. The control system of claim 1, wherein the processor is configured to search for the external person equipped with the user terminal in which a predetermined application is provided.

6. The control system of claim 1, wherein the processor is configured to:
search for the external person who is able to provide a callout engineer for customer service when the callout engineer for the customer service is required due to a failure of the autonomous vehicle,
search for the external person who is able to provide a predetermined equipment when the predetermined equipment is required, and
search for an ambulance crew or a police officer who is able to move to the autonomous vehicle when abnormality occurs in an occupant of the autonomous vehicle.

7. The control system of claim 1, wherein the processor is configured to request the external person positioned within a predetermined distance from the autonomous vehicle to help through manipulation of an external notification window or external lighting of the autonomous vehicle.

8. The control system of claim 1, wherein the processor is configured to transmit a help request notification through an application of the user terminal of the external person

9. The control system of claim 1, wherein the processor, when requesting the help through the user terminal of the external person, is configured to provide at least one of a position of the autonomous vehicle, contents of the help request, or contents of compensation for providing the help to the user terminal.

10. The control system of claim 9, wherein the processor is configured to pay a fee as compensation for providing the help when the help is terminated after receiving approval for the request for the help of the user terminal of the external person.

11. An autonomous vehicle comprising:
an autonomous driving control apparatus including:
a processor that is configured to check a vehicle state of the autonomous vehicle to determine whether human help is required to resolve a situation in which autonomous driving control of the autonomous vehicle is impossible, and when the human help is required, to request an in-vehicle occupant to help or an external person to help through a control system, and
an interface device outputting a phrase or a voice to request the help from the external person through the control system or to request the help from the in-vehicle occupant by remote control of the control system.

12. The autonomous vehicle of claim 11, wherein the processor is configured to notify an end of the help through the interface device when receiving a notification of the end of the help from the control system.

13. The autonomous vehicle of claim 11, further including:
a communication device that is configured to perform communication to request the help through the control system, and to transmit vehicle information together when requesting the help through the control system.

14. The autonomous vehicle of claim 11, wherein the processor is configured to output a text or voice requesting help through an external notification window of the autonomous vehicle or to blink an external light of the autonomous vehicle in accordance with a command of the control system.

15. The autonomous vehicle of claim 11, wherein cases that require the human help include at least one of a case that requires a callout engineer for customer service, a case that requires a predetermined equipment, a case that abnormality occurs in an occupant of the vehicle, a case that an obstacle outside the vehicle needs to be moved, or a case that a door or a tailgate of the vehicle is open.

16. The autonomous vehicle of claim 15, wherein the case that requires the callout engineer for the customer service includes at least one of tire replacement, air pressure injection, replacement of insufficient washer fluid or antifreeze, or lamp replacement.

17. The autonomous vehicle of claim 15, wherein the case that requires the predetermined equipment includes a case in which a request for cooperation of a loading forklift is required or a case in which cleaning of autonomous driving sensors of the vehicle is required.

18. The autonomous vehicle of claim 11, wherein the processor is configured to request the help from the in-vehicle occupant through the interface device when it is necessary to move an obstacle outside the vehicle, or when a door or a tailgate of the autonomous vehicle is open.

19. A remote control method for an autonomous vehicle, the remote control method comprising:
checking, by a processor, a vehicle state of the autonomous vehicle;
determining, by the processor, whether human help is required to resolve a situation in which autonomous driving control of the autonomous vehicle is impossible when the vehicle state is a situation in which the autonomous driving control of the autonomous vehicle is impossible; and
requesting, by the processor, help from an in-vehicle occupant or an external person through a control system when the human help is required.

20. The remote control method of claim 19, further including:
searching for, by the processor, the external person around the autonomous vehicle when receiving a request for the help of the external person from the autonomous vehicle, and requesting, by the processor, the help through a user terminal of the searched external person or an external notification of the autonomous vehicle, by the control system.
